(19) United States
(12) Patent Application Publication
(10) Pub. No.: US 2015/0103667 A1
(43) Pub. Date: Apr. 16, 2015

(54) DETECTION OF ROOT AND VICTIM NETWORK CONGESTION

(71) Applicant: Mellanox Technologies Ltd., Yokneam, IL (US)

(72) Inventors: George Elias, Tel Aviv (IL); Eyal Srebro, Akko (IL); Ido Bukspan, Herzeliya (IL); Itamar Rabenstein, Petah Tikva (IL); Ran Ravid, Tel Aviv (IL); Barak Gafni, Ramat Hasharon (IL); Anna Saksonov, Holon (IL)

(73) Assignee: Mellanox Technologies Ltd., Yokneam, IL (US)

(21) Appl. No.: 14/052,743

(22) Filed: Oct. 13, 2013

(51) Int. Cl. H04L 12/801

(52) U.S. Cl. CPC H04L 47/10
USPC 370/236

(57) ABSTRACT

A method in a communication network includes defining a root congestion condition for a network switch if the switch creates congestion in the network while switches downstream are congestion free, and a victim congestion condition if the switch creates the congestion as a result of one or more other congested switches downstream. A buffer fill level in a first switch, created by network traffic, is monitored. A binary notification is received from a second switch, which is connected to the first switch. A decision whether the first switch or the second switch is in a root or a victim congestion condition is made, based on both the buffer fill level and the binary notification. A network congestion control procedure is applied based on the decided congestion condition.

### FIELD OF THE INVENTION

The present invention relates generally to communication networks, and particularly to methods and systems for network congestion control.

### BACKGROUND OF THE INVENTION

In data communication networks, network congestion may occur, for example, when a buffer, port or queue of a network switch is overloaded with traffic. Techniques that are designed to resolve congestion in data communication networks are referred to as congestion control techniques. Congestion in a switch can be identified as root or victim congestion. A network switch is in a root congestion condition if the switch creates congestion while switches downstream are congestion free. The switch is in a victim congestion condition if the congestion is caused by other congested switches downstream.

Techniques for congestion control in networks with credit based flow control (e.g., Infiniband) using the identification of root and victim congestion are known in the art. For example, in the “Encyclopedia of parallel computing,” Sep. 8, 2011, Page 930, which is incorporated herein by reference, the authors assert that a switch port is a root of a congestion if it is sending data to a destination faster than it can receive, thus using up all the flow control credits available on the switch link. On the other hand, a port is a victim of congestion if it is unable to send data on a link because another node is using up all of the available flow-control credits on the link. In order to identify whether a port is the root of the victim of congestion, Infiniband architecture (IBA) specifies a simple approach. When a switch port notices congestion, if it has no flow-control credits left, then it assumes it is a victim of congestion.

As another example, in “On the Relation Between Congestion Control, Switch Arbitration and Fairness,” 11th IEEE/ACM International Symposium on Cluster, Cloud and Grid Computing (CCGrid), May 23-26, 2011, which is incorporated herein by reference, Gran et. al. assert that when congestion occurs in a switch, a congestion tree starts to build up due to the backpressure effect of the link-level flow control. The switch where the congestion starts will be the root of a congestion tree that grows towards the source nodes contributing to the congestion. This effect is known as congestion spreading. The tree grows because buffers fill up through the switches as the switches run out of flow control credits.

Techniques to prevent and resolve spreading congestion are also known in the art. For example, U.S. Pat. No. 7,573,827, whose disclosure is incorporated herein by reference, describes a method of detecting congestion in a communications network and a network switch. The method comprises identifying an output link of a network switch as a congested link on the basis of a packet in a queue of the network switch which is destined for the output link, where the output link has a predetermined state, and identifying a packet in a queue of the network switch as a packet generating congestion if the packet is destined for a congested link.

U.S. Pat. No. 8,391,144, whose disclosure is incorporated herein by reference, describes a network switching device that comprises first and second ports. A queue communicates with the second port, stores frames for later output by the second port, and generates a congestion signal when filled above a threshold. A control module selectively sends an outgoing flow control message to the first port when the congestion signal is present, and selectively instructs the second port to assert flow control when a flow control message is received from the first port if the received flow control message designates the second port as a target.

U.S. Pat. No. 7,839,779, whose disclosure is incorporated herein by reference, describes a network flow control system, which utilizes flow-aware pause frames that identify a specific virtual stream to pause. Special codes may be utilized to interrupt a frame being transmitted to insert a pause frame without waiting for frame boundaries.

U.S. Patent Application Publication 2006/0088036, whose disclosure is incorporated herein by reference, describes a method of traffic management in a communication network, such as a Metro Ethernet network, in which communication resources are shared among different virtual connections each carrying data flows relevant to one or more virtual networks and made up of data units comprising a tag with an identifier of the virtual network the flow refers to, and of a class of service allotted to the flow, and in which, in case of a congestion at a receiving node, a pause message is sent back to the transmitting node for temporary stopping transmission. For a selective stopping at the level of virtual connection and possibly of class of service, the virtual network identifier and possibly also the class-of-service identifier are introduced in the pause message.

### SUMMARY OF THE INVENTION

An embodiment of the present invention that is described herein provides a method for applying congestion control in a communication network, including defining a root congestion condition for a network switch if the switch creates congestion in the network while switches downstream are congestion free, and a victim congestion condition if the switch creates the congestion as a result of one or more other congested switches downstream. A buffer fill level in a first switch, created by network traffic, is monitored. A binary notification is received from a second switch, which is connected to the first switch. A decision whether the first switch or the second switch is in a root or a victim congestion condition is made, based on both the buffer fill level and the binary notification. A network congestion control procedure is applied based on the decided congestion condition.

In some embodiments, deciding whether the first or second switch is in the root or victim congestion condition includes detecting the victim congestion condition when the buffer fill level exceeds a predefined level, and a time duration that elapsed since receiving the binary notification exceeds a predefined duration. In other embodiments, deciding whether the first or second switch is in the root or victim congestion condition includes detecting the root congestion condition when the buffer fill level exceeds a predefined level, and a time duration that elapsed since receiving the binary notification does not exceed a predefined duration.

In an embodiment, the network traffic flows from the first switch to the second switch, and monitoring the buffer fill level includes monitoring a level of an output queue of the first switch, and deciding whether the first or second switch is in the root or victim congestion condition includes deciding on the congestion condition of the first switch. In another embodiment, the network traffic flows from the second switch to the first switch, and monitoring the buffer fill level includes monitoring a level of an input buffer of the first switch, and deciding whether the first or second switch is in the root or victim congestion condition includes deciding on the congestion condition of the second switch.

In some embodiments, applying the congestion control procedure includes applying the congestion control procedure only in response to detecting the root congestion condition and not in response to detecting the victim congestion condition. In other embodiments, applying the congestion control procedure includes applying the congestion control procedure only after a predefined time that elapsed since detecting the victim congestion condition exceeds a predefined timeout.

There is additionally provided, in accordance with an embodiment of the present invention, apparatus for applying congestion control in a communication network. The apparatus includes multiple ports for communicating over the communication network and control logic. The control logic is configured to define a root congestion condition for a network switch if the switch creates congestion in the network while switches downstream are congestion free, and a victim congestion condition if the switch creates the congestion as a result of one or more other congested switches downstream, to monitor in a first switch a buffer fill level created by network traffic, to receive from a second switch, which is connected to the first switch, a binary notification, to decide whether the first switch or the second switch is in a root or a victim congestion condition based on both the buffer fill level and the binary notification, and to apply a network congestion control procedure based on the decided congestion condition.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for data communication, in accordance with an embodiment of the present invention;

FIG. 2 is a block diagram that schematically illustrates a network switch, in accordance with an embodiment of the present invention;

FIGS. 3, 4A and 4B are flow charts that schematically illustrate methods for detecting and distinguishing between root and victim congestion, in accordance with two embodiments of the present invention; and

FIG. 5 is a flow chart that schematically illustrates a method for selective congestion control, in accordance with an embodiment of the present invention.

### DETAILED DESCRIPTION OF EMBODIMENTS

### Overview

In contrast to credit based flow control, in which credit levels can be monitored frequently and at high resolution, in some networks flow control is carried out using binary notifications. Examples for networks that handle flow control using PAUSE notifications include, for example, Ethernet variants such as described in the IEEE specifications 802.3x, 1997, and 802.1Qbb, Jun. 16, 2011, which are both incorporated herein by reference. In networks that employ flow control, packets are not dropped, as network switches inform upstream switches when they cannot accept data at full rate. As a result, congestion in a given switch can spread to other switches upstream.

A PAUSE notification (also referred to as X_OFF notification) typically comprises a binary notification by which a switch whose input buffer is overfilled above a predefined threshold informs the switch upstream that delivers data to that input buffer to stop sending data. When the input buffer fill level drops below a predefined level the switch informs the sending switch to resume transmission by sending an X_ON notification. This on-and-off burst-like nature of PAUSE notifications prevents a switch from making accurate, low-delay and stable congestion control decisions.

Embodiments of the present invention that are described herein provide improved methods and systems for congestion control using root and victim congestion identification. In an embodiment, a network switch SW1 delivers traffic data stored in an output queue of the switch to another switch SW2. SW1 makes congestion control decisions based on the fill level of the output queue and on binary PAUSE notifications received from SW2. For example, when SW1 output queue fills above a predefined level for a certain time duration, SW1 first declares root congestion. If, in addition, SW1 receives a PAUSE notification from SW2, and the congestion persists for longer than a predefined timeout since receiving the PAUSE, SW1 declares victim congestion.

Based on the identified congestion type, i.e., root or victim, SW1 may apply suitable congestion control procedures. The predefined timeout is typically configured to be on the order of (or longer than) the time it takes to empty the switch input buffer when there is no congestion (T_EMPTY). Using a timeout on the order of T_EMPTY reduces the burst-like effect of the binary PAUSE notifications and improves the stability of the distinction decisions between root and victim.

In another embodiment, a network switch SW1 receives traffic data delivered out of an output queue of another switch SW2, and stores the data in an input buffer. SW2 sends to SW1 binary (i.e., on-and-off) congestion notifications when the fill level of the output queue exceeds a predefined high watermark level or drops below a predefined low watermark level. SW1 makes decisions regarding the congestion type or state of SW2 based on the fill level of its own input buffer and the congestion notifications received from SW2.

For example, when SW1 receives a notification that the output queue of SW2 is overfilled, SW1 declares that SW2 is in a root congestion condition. If, in addition, the fill level of SW1 input buffer exceeds a predefined level for a specified timeout duration, SW1 identifies that SW2 is in a victim congestion condition. Based on the congestion type, SW1 applies suitable congestion control procedures, or informs SW2 to apply such procedures. Since SW1 can directly monitor its input buffer at high resolution and rate, SW1 is able to make accurate decisions on the congestion type of SW2 and with minimal delay.

By using the disclosed techniques to identify root and victim congestion and to selectively apply congestion control procedures, the management of congestion control over the network becomes significantly more efficient. In some embodiments, the distinction between root and victim congestion is used for applying congestion control procedures only for root-congested switches, which are the cause of the congestion. In alternative embodiments, upon identifying that a switch is in a victim congestion condition for a long period of time, congestion control procedures are applied for this congestion, as well. This technique assists in resolving prolonged network congestion scenarios.

### System Description

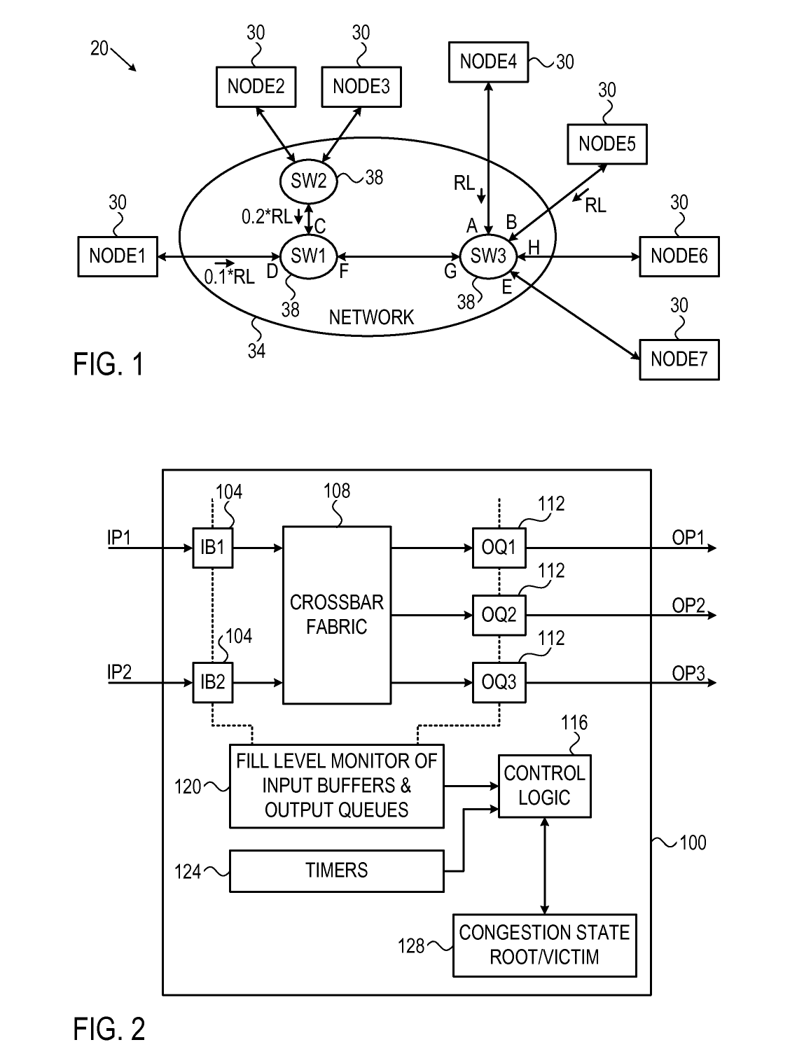

FIG. 1 is a block diagram that schematically illustrates a system 20 for data communication, in accordance with an embodiment of the present invention. System 20 comprises nodes 30, which communicate with each other over a data network 34. In the present example network 34 comprises an Ethernet™ network. The data communicated between two end nodes is referred to as a data stream. In the example of FIG. 1, network 34 comprises network switches 38, i.e., SW1, SW2, and SW3.

A network switch typically comprises two or more ports by which the switch connects to other switches. An input port comprises an input buffer to store incoming packets, and an output port comprises an output queue to store packets destined to that port. The input buffer as well as the output queue may store packets of different data streams. As traffic flows through a network switch, packets in the output queue of the switch are delivered to the input buffer of the downstream switch to which it is connected. A congested port is a port whose output queue or input buffer is overfilled.

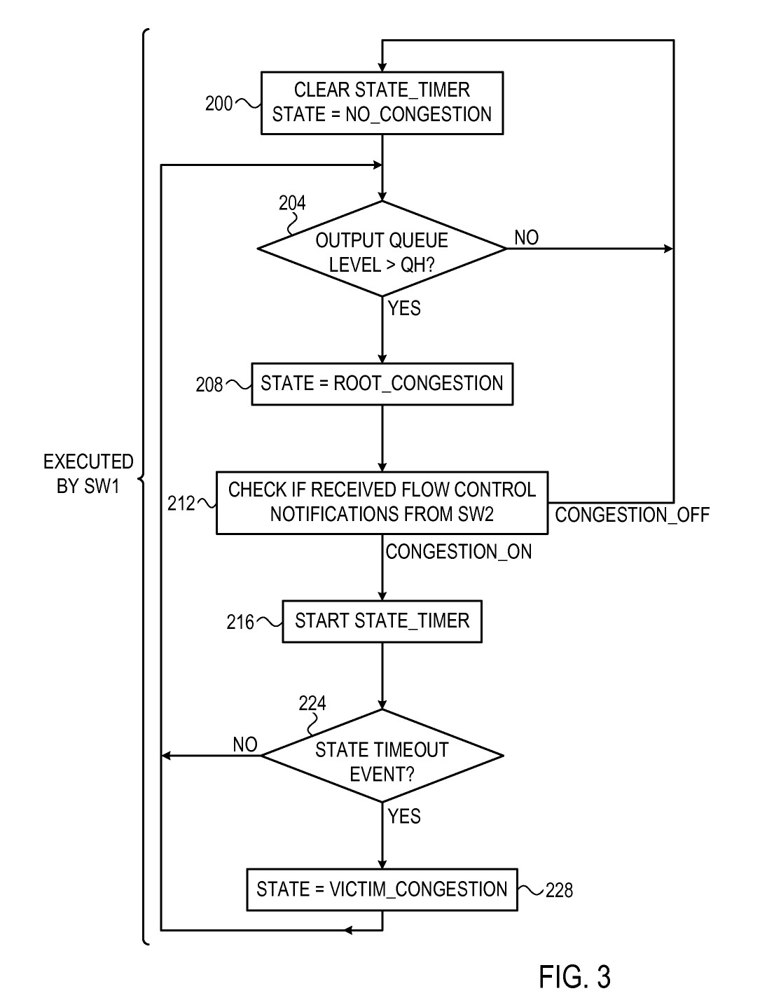

Typically, the ports of a network switch are bidirectional and function both as input and output ports. For the sake of clarity, however, in the description herein we assume that each port functions only as an input or output port. A network switch typically directs packets from an input port to an output port based on information that is sent in the packet header and on internal switching tables. FIG. 2. below provides a detailed block diagram of an example network switch.

In the description that follows, network 34 represents a data communication network and protocols for applications whose reliability does not depend on upper layers and protocols, but rather on flow control, and therefore data packets transmitted along the network should not be dropped by the network switches. Examples for such networks include, for example, Ethernet variants such as described in the IEEE specifications 802.3x and 802.1Qbb cited above. Nevertheless, the disclosed techniques are applicable in various other protocols and network types.

Some standardized techniques for network congestion control include mechanisms for congestion notifications to source end-nodes, such as Explicit Congestion Notification (ECN), which is designed for TCP/IP layer 3 and is described in RFC 3168, September 2001, and Quantized Congestion Notification (QCN), which is designed for Ethernet layer 2, and is described in IEEE 802.1Qau, Apr. 23, 2010. All of these references are incorporated herein by reference.

We now describe an example of root and victim congestion created in system 20 (FIG. 1), in accordance with an embodiment of the present invention. Assume that NODE1 sends data to NODE7, and NODE2, . . . , NODE5 send data to NODE6. The data stream sent from NODE1 to NODE7 passes through switches SW1, from port D to F, and SW3, from port G to E. Traffic sent form NODE2 and NODE3 to NODE6 passes through SW2, SW1 (from port C to F) and SW3 (from port G to H), and traffic sent from NODE4 and NODE5 to NODE6 passes only trough SW3 (from ports A and B to H). Let RL denote the line rate across the network connections. Further assume that each of the A and B ports of SW3 accept data at rate RL, port C of SW1 accepts data at rate 0.2*RL, and port D of SW1 accepts data at rate 0.1*RL. Under the above assumptions, the data rate over the connection between SW1 (port F) and SW3 (port G) should be equal to 0.3*RL, which is well below the line rate RL.

Since traffic input to ports A, B, and C is destined to port H, port H is oversubscribed to a 2.2*RL rate and thus becomes congested. As a result, packets sent from port C of SW1 to port G of SW3 cannot be delivered at the designed 0.2*RL rate to NODE6 via port H, and port G becomes congested. At this point, port G blocks at least some of the traffic arriving from port F. Eventually the output queue of port F overfills and SW1 becomes congested as well.

In the example described above, SW3 is in a root congestion condition since the congestion of SW3 was not created by any other switch (or end node) downstream. On the other hand, the congestion of SW1 was created by the congestion initiated in SW3 and therefore SW1 is in a victim congestion condition. Note that although the congestion was initiated at port H of SW3, data stream traffic from NODE1 to NODE7, i.e., from port D of SW1 to port E of SW3, suffers reduced bandwidth as well.

In embodiments that are described below, switches 38 are configured to distinguish between root and victim congestion, and based on the congestion type to selectively apply congestion control procedures. The disclosed methods provide improved and efficient techniques for resolving congestion in the network.

FIG. 2 is a block diagram that schematically illustrates a network switch 100, in accordance with an embodiment of the present invention. Switches SW1, SW2 and SW3 of network 34 (FIG. 1) may be configured similarly to the configuration of switch 100. In the example of FIG. 2, switch 100 comprises two input ports IP1 and IP2, and three output ports OP1, OP2, and OP3, for the sake of clarity. Real-life switches typically comprise a considerably larger number of ports, which are typically bidirectional.

Packets that arrive at ports IP1 or IP2 are stored in input buffers 104 denoted IB1 and IB2, respectively. An input buffer may store packets of one or more data streams. Switch 100 further comprises a crossbar fabric unit 108 that accepts packets from the input buffers (e.g., IB1 and IB2) and directs the packets to respective output ports. Crossbar fabric 108 typically directs packet based on information written in the headers of the packets and on internal switching tables. Methods for implementing switching using switching tables are known in the art. Packets destined to output ports OP1, OP2 or OP3 are first queued in respective output queues 112 denoted OQ1, OQ2 or OQ3. An output queue may store packets of a single stream or multiple different data streams that are all delivered via a single output port.

When switch 100 is congestion free, packets of a certain data stream are delivered through a respective chain of input port, input buffer, crossbar fabric, output queue, output port, and to the next hop switch at the required data rate. On the other hand, when packets arrive at a rate that is higher than the maximal rate or capacity that the switch can handle, one or more output queues and/or input buffers may overfill and create congestion.

Since system 20 employs flow control techniques, the switch should not drop packets, and overfill of an output queue creates backpressure on input buffers of the switch. Similarly, an overfilled input buffer may create backpressure on an output queue of a switch upstream. Creating backpressure refers to a condition in which a receiving side signals to the sending side to stop or throttle down delivery of data (since the receiving side is overfilled).

Switch 100 comprises a control logic module 116, which manages the operation of the switch. In an example embodiment, control logic 116 manages scheduling of packets delivery through the switch. Control logic 116 accepts fill levels of input buffers IB1, and IB2, and output queues OP1, OP2, and OP3, which are measured by a fill level monitor unit 120. Fill levels can be monitored for different data streams separately.

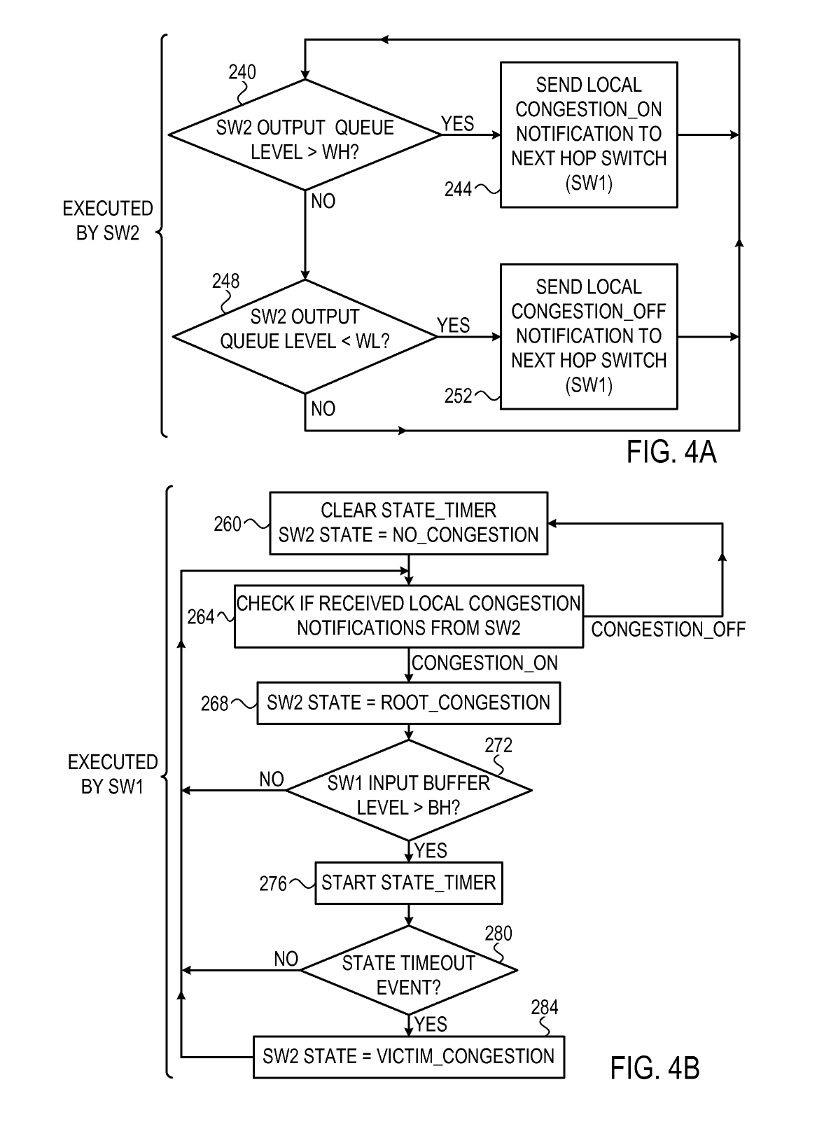

Control logic 116 can measure time duration elapsed between certain events using one or more timers 124. For example, control logic 116 can measure the elapsed time since a buffer becomes overfilled, or since receiving certain flow or congestion control notifications. Based on inputs from units 120 and 124, control logic 116 decides whether the switch is in a root or victim congestion condition and sets a congestion state 128 accordingly. In some embodiments, instead of internally estimating its own congestion state, the switch determines the congestion state of another switch and stores that state value in state 128. Methods for detecting root or victim congestion are detailed in the description of FIGS. 3, 4A, and 4B below.

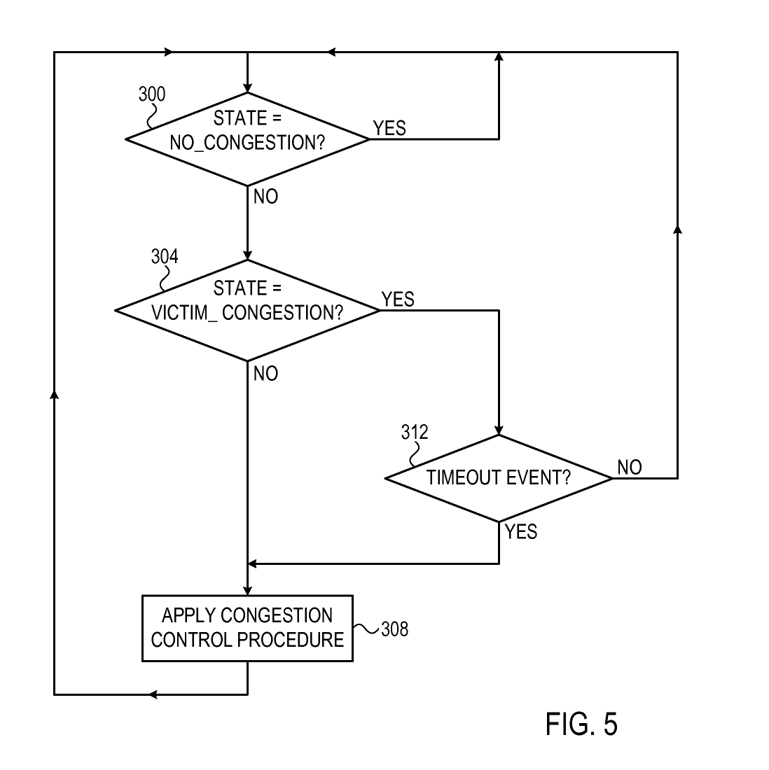

Based on the congestion state, control logic 116 applies respective congestion control procedures. FIG. 5 below describes a method of selective application of a congestion control procedure based on the congestion state. The congestion control procedure may comprise any suitable congestion control method as known in the art. Examples for congestion control methods that may be selectively applied include Explicit Congestion Notification (ECN) and Quantized Congestion Notification (QCN) whose IEEE specifications are cited above.

The configuration of switch 100 in FIG. 2 is an example configuration, which is chosen purely for the sake of conceptual clarity. In alternative embodiments, any other suitable configuration can also be used. The different elements of switch 100 may be implemented using any suitable hardware, such as in an Application-Specific Integrated Circuit (ASIC) or Field-Programmable Gate Array (FPGA). In some embodiments, some elements of the switch can be implemented using software, or using a combination of hardware and software elements. For example, in the present disclosure, control logic 116, input buffers 104, and output queues 112 can be each implemented in separated ASIC or FPGA modules. Alternatively, the input buffers and output queues can be implemented on a single ASIC or FPGA that may possibly also include the control logic and other components.

In some embodiments, control logic 116 comprises a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

### Detecting Root or Victim Congestion

FIGS. 3, and 4A and 4B, are flow charts that schematically illustrate methods for detecting and distinguishing between root and victim congestion, in accordance with embodiments of the present invention. In the described methods two switches, i.e., SW1 and SW2 are interconnected. SW1 receives flow or congestion control notifications from SW2 and determines the congestion state. In the method of FIG. 3 SW1 is connected upstream to SW2 so that traffic flows from SW1 to SW2. In this method SW2 sends binary flow control messages or notifications to SW1. In the methods of FIGS. 4A and 4B SW1 is connected downstream to SW2 and traffic flows from SW2 to SW1. In these methods, SW2 sends local binary congestion control notifications to SW1. In the described embodiments, SW1 and SW2 are implemented similarly to switch 100 of FIG. 2.

In the context of the description that follows and in the claims, the fill level of an input buffer or an output queue refers to a fill level that corresponds to a single data stream, or alternatively to the fill level that corresponds to multiple data streams together. Thus, control logic 116 can operate congestion control per each data stream separately, or alternatively, for multiple streams en-bloc.

The method of FIG. 3 is executed by SW1 and begins with control logic 116 performing initiation, at an initiation step 200. At step 200 the control logic sets congestion state 128 (STATE in the figure) to NO_CONGESTION, and clears a STATE_TIMEOUT timer (e.g., one of timers 124). At a level monitoring step 204, the control logic checks whether any of the output queues 112 is overfilled. The control logic accepts monitored fill levels from monitor unit 120 and compares the fill levels to a predefined threshold QH. In some embodiments, different QH thresholds are used for different data streams. If none of the fill levels of the output queues exceeds QH the control logic loops back to step 200. Otherwise, the fill level of one or more of the output queues exceeds the threshold QH, and the control logic sets the congestion state to ROOT_CONGESTION, at a setting root step 208. In some embodiments, the control logic sets the state to ROOT_CONGESTION at step 208 only after the queue level persistently exceeds QH (at step 204) for a predefined time duration. The time duration is configurable and should be on the order of T1, which is defined below in relation to step 224.

At step 212, the control logic checks whether SW1 received a congestion notification, i.e., CONGESTION_ON or NOTIFICATION_OFF from SW2. In some embodiments, the CONGESTION_ON and CONGESTION_OFF notifications comprise a binary notification (e.g., a PAUSE X_OFF or X_ON notification respectively) that signals overfill or under fill of an input buffer in SW2. Standardized methods for implementing PAUSE notifications are described, for example, in the IEEE 802.3x and IEEE 802.1Qbb specifications cited above. In alternative embodiments, however, any other suitable congestion notification method can be used.

If at step 212 the control logic finds that SW1 received CONGESTION_OFF notification (e.g., a PAUSE X_ON notification) from SW2, the control logic loops back to step 200. Otherwise, if the control logic finds that SW1 received CONGESTION_ON notification (e.g., a PAUSE X_OFF notification) from SW2, the control logic starts the STATE_TIMER timer, at a timer starting step 216. The control logic starts the timer at step 216 only if the timer is not already started.

If at step 212 the control logic finds that SW1 received none of the CONGESTION_OFF or CONGESTION_ON notifications, the control logic loops back to step 200 or continues to step 216 according to the most recently received notification.

At a timeout checking step 224, the control logic checks whether the time that elapsed since the STATE_TIMER timer was started (at step 216) exceeds a predefined configurable duration denoted T1. If the result at step 224 is negative the control logic does not change the ROOT_CONGESTION state and loops back to step 204. Otherwise, the control logic transitions to a VICTIM_CONGESTION state, at a victim setting step 228 and then loops back to step 204 to check whether the output queue is still overfilled. State 128 remains set to VICTIM_CONGESTION until the output queue level drops below QH at step 204, or a CONGESTION_OFF notification is received at step 212. In either case, SW1 transitions from VICTIM_CONGESTION to NO_CONGESTION state.

At step 224 above, the (configurable) time duration T1 that is measured by SW1 before changing the state to VICTIM_CONGESTION should be optimally selected. Assume that T_EMPTY denotes the average time that takes in SW2 to empty a full input buffer via a single output port (when SW2 is not congested). Then, T1 should be configured to be on the order of a few T_EMPTY units. When T1 is selected to be too short, SW1 may transition to the VICTIM_CONGESTION state even when the input buffer in SW2 empties (relatively slow) to resolve the congestion. On the other hand, when T1 is selected to be too long the transition to the VICTIM_CONGESTION state is unnecessarily delayed. Optimal configuration of T1 ensures that SW1 transitions to the VICTIM_CONGESTION state with minimal delay when the congestion in SW2 persists with no ability to empty the input buffer.

In the method described in FIG. 3, SW1 detects a congestion condition and determines whether the switch itself (i.e., SW1) is in a root or victim congestion condition. FIG. 5 below described a method that may be executed by SW1 in parallel with the method of FIG. 3, to selectively apply a congestion control procedure based on the congestion state (i.e., root or victim congestion).

In an example embodiment whose implementation is given by the methods described in FIGS. 4A and 4B below, a network switch SW1 is connected downstream to another switch SW2, so that data traffic flows from SW2 to SW1. The method described in FIG. 4A is executed by SW2, which sends local binary congestion notifications to SW1. The method of FIG. 4B is executed by SW1, which determines whether SW2 is in a root or victim congestion condition. In the description of the methods of FIGS. 4A and 4B below, modules such as control logic 116, input buffers 104, output queues 112, etc., refer to the modules of the switch that executes the respective method.

The method of FIG. 4A begins with control logic 116 (of SW2) checking the fill level of output queues 112 of SW2, at a high level checking step 240. If at step 240 the control logic finds an output queue whose fill level exceeds a predefined watermark level WH, the control logic sends a local CONGESTION_ON notification to SW1, at an overfill indication step 244. If at step 240 none of the fill levels of the output queues exceeds WH, the control logic proceeds to a low level checking step 248. At step 248, the control logic checks whether the fill level of any of the output queues 112 drops below a predefined watermark level WL.

If at step 248 the control logic detects an output queue whose fill level is below WL, the control logic sends a local CONGESTION_OFF notification to SW1, at a congestion termination step 252. Following steps 244, 252, and 248 when the fill level of the relevant output queue is below WL, control logic 116 loops back to step 240. Note that at step 244 (and 252) SW2 sends a notification only once after the condition at step 240 (or 248) is fulfilled, so that SW2 avoids sending redundant notifications to SW1. To summarize, in the method of FIG. 4A, SW2 informs SW1 (using local binary congestion notifications) whenever the fill level of any of the output queues (of SW2) is not maintained between the watermarks WL and WH.

The control logic can use any suitable method for sending the local notifications at steps 244 and 252 above. For example, the control logic can send notifications over unused fields in the headers of the data packets (e.g., Ether Type fields). Additionally or alternatively, the control logic may send notifications over extended headers of the data packets using, for example, flow-tag identifiers. Further additionally or alternatively, the control logic can send notifications using additional new formatted non-data packets. As yet another alternative, the control logic may send notification messages over a dedicated external channel, which is managed by system 20. The described methods may be also used by SW1 to indicate to SW2 the congestion state as described further below.

The method of FIG. 4B is executed by SW1 and begins with control logic 116 performing initiation, at an initiation step 260. Similarly to step 200 of FIG. 3, at step 260 the control logic clears a timer denoted STATE_TIMER and sets congestion state 128 to NO_CONGESTION. Note, however, that in the method of FIG. 3 the control logic of SW1 determines the congestion state of the switch itself, whereas in the method of FIG. 4B the control logic of SW1 determines the congestion state of SW2.

At a notification checking step 264, the control logic checks whether SW1 received from SW2 a CONGESTION_OFF or NOTIFICATION_ON notification. If SW1 received a CONGESTION_OFF notification the control logic loops back to step 260. On the other hand, if at step 264 the control logic finds that SW1 received a CONGESTION_ON notification from SW2 the control logic sets congestion state 128 to ROOT_CONGESTION, at a root setting step 268. In some embodiments, the control logic sets state 128 (at step 268) to ROOT_CONGESTION only if no CONGESTION_OFF notification is received at step 264 for a suitable predefined duration. If no notification was received at step 264, the control logic loops back to step 260 or continues to step 268 based on the most recently received notification.

Next, the control logic checks the fill level of the input buffers 104, at a fill level checking step 272. The control logic compares the fill level of the input buffers monitored by unit 120 to a predefined threshold level BH. In some embodiments, the setting of BH (which may differ between different data streams) indicates that the input buffer is almost full, e.g., the available buffer space is smaller than the maximum transmission unit (MTU) used in system 20. If at step 272 the fill level of all the input buffers is found below BH, the control logic loops back to step 264. Otherwise, the fill level of at least one input buffer exceeds BH and the control logic starts the STATE_TIMER timer, at a timer starting step 276 (if the timer is not already started).

Next, the control logic checks whether the time elapsed since the STATE_TIMER was started (at step 276) exceeds a predefined timeout, at a timeout checking step 280. If at step 280 the elapsed time does not exceed the predefined timeout, the control logic keeps the congestion state 128 set to ROOT_CONGESTION and loops back to step 264. Otherwise, the control logic sets congestion state 128 to VICTIM_CONGESTION, at a victim congestion setting step 284, and then loops back to step 264.

When SW1 sets state 128 to NO_CONGESTION, ROOT_CONGESTION, or VICTIM_CONGESTION (at steps 260, 268, and 284, respectively), SW1 may indicate the new state value to SW2 immediately. Alternatively, SW1 can indicate the state value to SW2 at using any suitable time schedule, such as periodic notifications. SW1 may use any suitable communication method for indicating the congestion state value to SW2 as described above in FIG. 4A.

In the methods of FIGS. 4A and 4B, although SW1 gets binary congestion notifications from SW2, the fill level of input buffers 104 can be monitored at high resolution, and therefore the methods enable the detection of root and victim congestion with high sensitivity. Moreover, since SW2 directly monitors the fill level of the input buffers (as opposed to using PAUSE notifications), the monitoring incurs no extra delay, and the timeout at step 280 can be configured to a short duration, i.e., smaller than T_EMPTY defined in the method of FIG. 3 above, thus significantly reducing delays in making congestion control decisions.

### Selective Application of Congestion Control

FIG. 5 is a flow chart that schematically illustrates a method for selective congestion control, in accordance with an embodiment of the present invention. The method can be executed by SW1 in parallel with the methods for detecting and distinguishing between root and victim congestion as described in FIGS. 3, and 4B above. The congestion state (STATE) in FIG. 5 corresponds to congestion state 128 of SW1, which corresponds to the congestion condition of either SW1 in FIG. 3 or SW2 in FIG. 4B.

The method of FIG. 5 begins with control logic 116 checking whether congestion state 128 equals NO_CONGESTION, at a congestion checking step 300. Control logic 116 repeats step 300 until the congestion state no longer equals NO_CONGESTION, and then checks whether the congestion state is equal to VICTIM_CONGESTION, at a victim congestion checking step 304. A negative result at step 304 indicates that the congestion state equals ROOT_CONGESTION and the control logic applies a suitable congestion control procedure, at a congestion control application step 308, and then loops back to step 300. If at step 304 the result is positive, the control logic checks a timeout event, at a checking timeout event step 312. More specifically, at step 312 the control logic checks whether the time elapsed since the switch entered the VICTIM_CONGESTION state exceeds a predefined duration. If the result at step 312 is negative, the control logic loops back to step 300. Otherwise, the control logic applies the congestion control procedure at step 308. Note that prior to the occurrence of the timeout event SW1 applies the congestion control procedure only if the switch is found to be in a root congestion condition. Following the timeout event, i.e., when the result at step 312 is positive, SW1 applies the congestion control procedure when the switch is either in the root or victim congestion condition, which may aid in resolving persistent network congestion. When congestion is resolved and state 128 returns to NO_CONGESTION state, application of the congestion control procedure at step 308 is disabled.

The methods described above in FIGS. 3, 4A and 4B are exemplary methods, and other methods can be used in alternative embodiments. For example, an embodiment that implements the method of FIG. 4A, can use equal watermark levels, i.e., WL=WH, thus unifying steps 240 and 248 accordingly. As another example, when the method of FIG. 5 is executed by SW1 in parallel with the method of FIG. 4B, SW1 selectively applies congestion control procedures. In alternative embodiments, however, SW1 informs SW2 the detected congestion state (i.e., root or victim) and SW2 applies selective congestion control, or alternatively fully executes the method of FIG. 5. SW1 can use any suitable method to inform SW2 of the congestion state, such as the methods for sending notifications at steps 244 and 252 mentioned above.

In some embodiments, the methods described in FIGS. 3, 4A and 4B, to distinguish between root and victim congestion may be enabled for some output queues, and disabled for others. For example, it may be advantageous to disable the ability to distinguish between root and victim congestion when the output queue delivers data to an end node that can accept the data at a rate lower than the line rate. For example, when a receiving end node such as Host Channel Adapter (HCA) creates congestion backpressure upon the switch that delivers data to the HCA, the switch should behave as root congested rather than victim congested.

The methods described above refer mainly to networks such as Ethernet, in which switches should not drop packets, and in which flow control is based on binary notifications. The disclosed methods, however, are applicable to other data networks such as and IP (e.g., over Ethernet) networks.

Although the embodiments described herein mainly address handling network congestion by the network switches, the methods and systems described herein can also be used in other applications, such as in implementing the congestion control techniques in network routers or in any other network elements.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method in a communication network, comprising:
defining a root congestion condition for a network switch if the switch creates congestion in the network while switches downstream are congestion free, and a victim congestion condition if the switch creates the congestion as a result of one or more other congested switches downstream.
monitoring in a first switch a buffer fill level created by network traffic;
receiving from a second switch, which is connected to the first switch, a binary notification;
deciding whether the first switch or the second switch is in a root or a victim congestion condition based on both the buffer fill level and the binary notification; and
applying a network congestion control procedure based on the decided congestion condition.

2. The method according to claim 1, wherein deciding whether the first or second switch is in the root or victim congestion condition comprises detecting the victim congestion condition when the buffer fill level exceeds a predefined level, and a time duration that elapsed since receiving the binary notification exceeds a predefined duration.

3. The method according to claim 1, wherein deciding whether the first or second switch is in the root or victim congestion condition comprises detecting the root congestion condition when the buffer fill level exceeds a predefined level, and a time duration that elapsed since receiving the binary notification does not exceed a predefined duration.

4. The method according to claim 1, wherein the network traffic flows from the first switch to the second switch, wherein monitoring the buffer fill level comprises monitoring a level of an output queue of the first switch, and wherein deciding whether the first or second switch is in the root or victim congestion condition comprises deciding on the congestion condition of the first switch.

5. The method according to claim 1, wherein the network traffic flows from the second switch to the first switch, wherein monitoring the buffer fill level comprises monitoring a level of an input buffer of the first switch, and wherein deciding whether the first or second switch is in the root or victim congestion condition comprises deciding on the congestion condition of the second switch.

6. The method according to claim 1, wherein applying the congestion control procedure comprises applying the congestion control procedure only in response to detecting the root congestion condition and not in response to detecting the victim congestion condition.

7. The method according to claim 1, wherein applying the congestion control procedure comprises applying the congestion control procedure only after a predefined time that elapsed since detecting the victim congestion condition exceeds a predefined timeout.

8. Apparatus in a communication network, comprising:
multiple ports for communicating over the communication network; and
control logic, which is configured to define a root congestion condition for a network switch if the switch creates congestion in the network while switches downstream are congestion free, and a victim congestion condition if the switch creates the congestion as a result of one or more other congested switches downstream, to monitor in a first switch a buffer fill level created by network traffic, to receive from a second switch, which is connected to the first switch, a binary notification, to decide whether the first switch or the second switch is in a root or a victim congestion condition based on both the buffer fill level and the binary notification, and to apply a network congestion control procedure based on the decided congestion condition.

9. The apparatus according to claim 8, wherein the control logic is configured to detect the victim congestion condition when the buffer fill level exceeds a predefined level, and a time duration that elapsed since receiving the binary notification exceeds a predefined duration.

10. The apparatus according to claim 8, wherein the control logic is configured to detect the root congestion condition when the buffer fill level exceeds a predefined level, and a time duration that elapsed since receiving the binary notification does not exceed a predefined duration.

11. The apparatus according to claim 8, wherein the network traffic flows from the first switch to the second switch, and wherein the control logic is configured to monitor a level of an output queue of the first switch, and to decide on the congestion condition of the first switch.

12. The apparatus according to claim 8, wherein the network traffic flows from the second switch to the first switch, and wherein the control logic is configured to monitor a level of an input buffer of the first switch, and to decide on the congestion condition of the second switch.

13. The apparatus according to claim 8, wherein the control logic is configured to apply the congestion control procedure only in response to detecting the root congestion condition and not in response to detecting the victim congestion condition.

14. The apparatus according to claim 8, wherein the control logic is configured to apply the congestion control procedure only after a time that elapsed since detecting the victim congestion condition exceeds a predefined timeout.
